(19) United States
(12) Patent Application Publication
(10) Pub. No.: US 2012/0304962 A1
(43) Pub. Date: Dec. 6, 2012

(54) METHOD FOR ESTIMATING A COMBUSTION TORQUE OF AN INTERNAL COMBUSTION ENGINE AND CONTROL UNIT FOR AN INTERNAL COMBUSTION ENGINE

(75) Inventors: Charles Francois Tumelaire, Brixworth (GB); Aaron John Oakley, Chelmsford (GB); Laurence Paul Hatfield, Horton Kirby (GB)

(73) Assignee: FORD GLOBAL TECHNOLOGIES, LLC, Dearborn, MI (US)

(21) Appl. No.: 13/482,483

(22) Filed: May 29, 2012

(30) Foreign Application Priority Data
May 30, 2011 (EP) 11168103.7

(51) Int. Cl. F02D 28/00

(52) U.S. Cl. 123/349

(57) ABSTRACT

A method for estimating a combustion torque acting upon a crankshaft of an internal combustion engine is described. In one example, the method includes acquiring an instantaneous engine speed signal, calculating a cyclic engine speed signal based on the instantaneous engine speed signal, averaging the cyclic engine speed signal, correcting the averaged cyclic engine speed signal for engine losses, and estimating the combustion torque based on the corrected averaged cyclic engine speed signal. The description also concerns a control unit for an internal combustion engine.

### RELATED APPLICATIONS

The present application claims priority to European Patent Application Number 11168103.7, filed on May 30, 2011, the entire contents of which are hereby incorporated by reference for all purposes.

### FIELD

The present description relates to a method for estimating combustion torque of an internal combustion engine. The method may provide a simplified approach to engine torque estimation.

### BACKGROUND AND SUMMARY

In internal combustion engines, the engine torque generated by combustion represents important information for the engine and transmission control. In particular, control of the engine aftertreatment devices and control of the vehicle transmission requires an accurate estimate of the torque during combustion mode changes or gear shift, respectively. Additionally, the engine torque estimate may be a basis for adjusting engine throttle position and fuel injection to the engine.

According to the state of the art, the combustion torque typically is measured during the engine and vehicle development and calibration. Such torque measurement relies on direct or indirect measurement of the combustion event in order to evaluate the torque produced by the combustion of the injected fuel. In the case of direct measurement, in-cylinder pressure is measured and used to calculate the net heat release rate as well as the indicated work and torque. For the case of indirect measurement, the brake torque is measured on an engine dynamometer and used to re-construct the torque produced by combustion. Such measurements, however, are subject to high cost and/or strong limitations.

Alternatively, the measured crank shaft rotational speed can be employed for obtaining information on the in-cylinder combustion event and for estimating the combustion torque. According to DE 10 2009 001 128 A1, the peak-to-peak variation of the crankshaft speed signal during a given period of time is evaluated for estimating the combustion torque of the engine. However, errors in the estimated engine torque may arise when engine torque is estimated simply based on peak-to-peak variation of crankshaft speed.

The inventors herein have recognized the above-mentioned disadvantages and have developed a method for operating an engine, comprising: adjusting an actuator in response to an estimated engine combustion torque, the estimated engine combustion torque based on an engine loss corrected averaged cyclic speed as determined from an averaged cyclic engine speed, the averaged cyclic engine speed based on a cyclic engine speed, the cyclic engine speed based on instantaneous engine speed.

By estimating engine combustion torque from an averaged cyclic engine speed, it may be possible to improve engine combustion torque estimation. In particular, measurement and signal noise within the engine speed signal may be reduced so that an estimate of engine torque via the averaged cyclic engine speed may be improved.

The present description may provide several advantages. Specifically, the approach may provide improved torque estimation accuracy. Additionally, the approach may be implemented with existing types of engine speed sensors. Further, the approach may be performed without a dynamometer and in-cylinder pressure sensors.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an example, referred to herein as the Detailed Description, when taken alone or with reference to the drawings, where:

FIG. 1 is a schematic diagram of an engine;

FIG. 2 shows in a graphical representation the results of measurements of the instantaneous engine speed depending on the torque set-point;

FIG. 3 is a simplified flow diagram of an example of a method for estimating a combustion torque of an internal combustion engine; and

FIG. 4 is a simplified flow diagram of an example of an update procedure of the inertia compensation.

### DETAILED DESCRIPTION

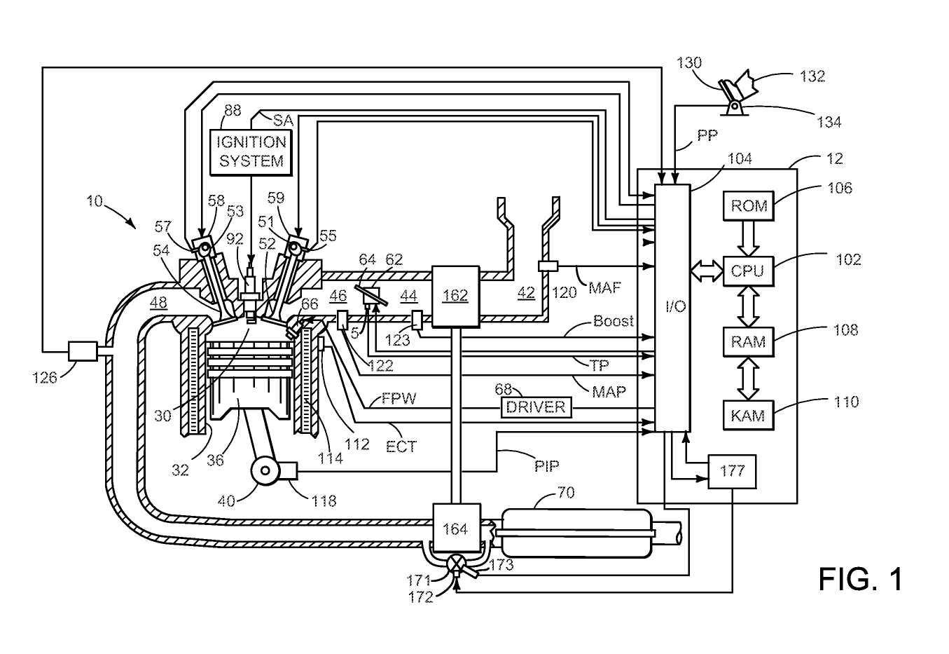

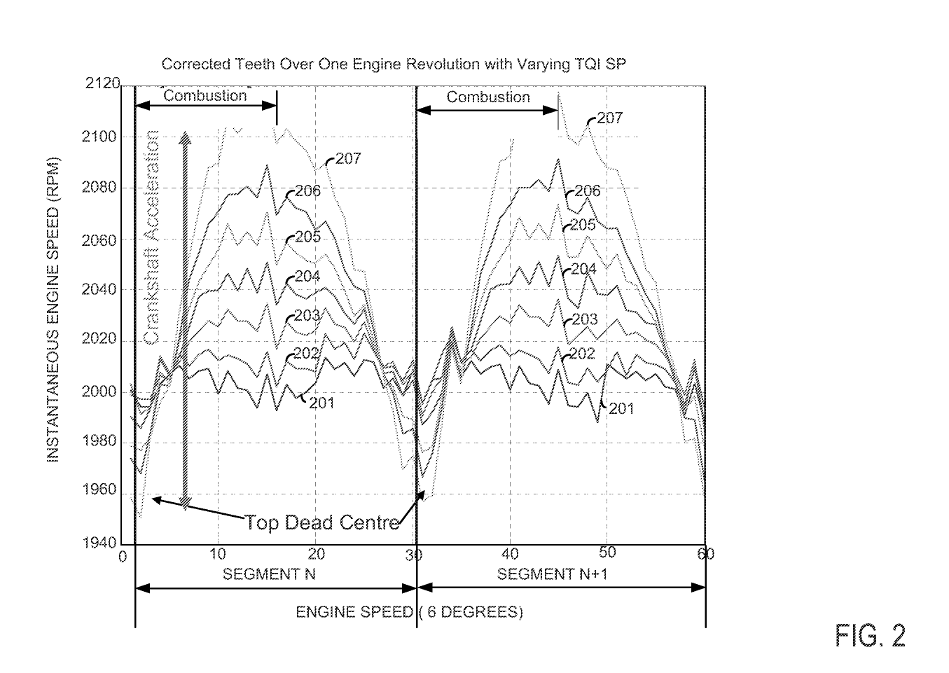

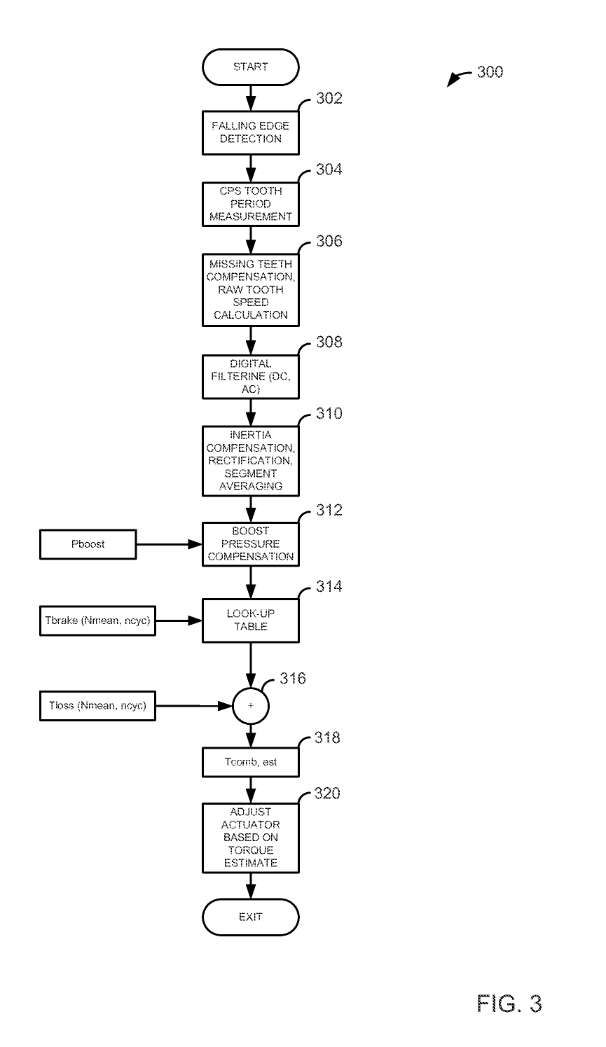

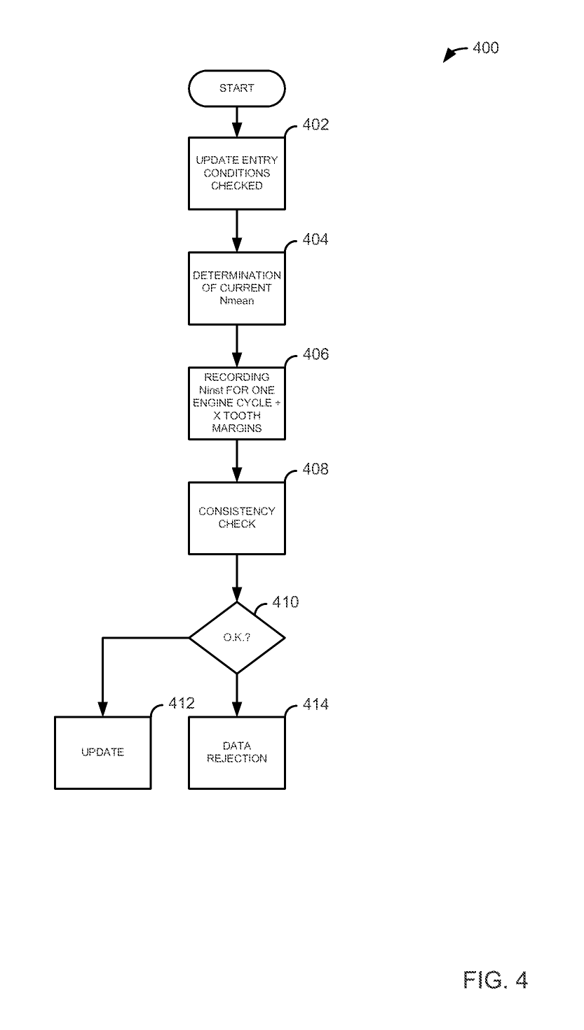

The present description is related to estimating combustion torque of an engine in response to an engine speed. In one non-limiting example, the engine may be configured as illustrated in FIG. 1. Engine torque estimated according to the present approach exhibits different profiles for different engine torques as shown in FIG. 2. One example approach for estimating engine torque is shown in FIG. 3. An update procedure for updating inertia compensation is shown in FIG. 4.

It is an object of the present description to provide an improved method for estimating a combustion torque of an internal combustion engine. It is a further object of the description to provide a control unit for an internal combustion engine which is equipped for estimating the combustion torque of the engine in an improved manner.

The inventive method for estimating a combustion torque of an internal combustion engine is based on analysing the instantaneous engine speed signal obtained from a crankshaft position sensor (CPS) with which modern internal combustion engines are equipped. Such crankshaft position sensors usually consist of an encoder detecting the motion of structures fixed to the crankshaft, e.g., the leading and/or falling edges of teeth of a target wheel mounted to the crankshaft. In particular, the time intervals between consecutive interrupts from high to low or vice versa of the target wheel tooth transitions can be acquired. Missing teeth which indicate an angular reference position can be reconstructed by interpolation. By inversion of the time intervals, an instantaneous or raw engine speed signal can be obtained.

The inventive method comprises the step of acquiring an instantaneous engine speed signal from the crankshaft position sensor. This step may comprise calculating the instantaneous engine speed signal from a signal provided by the sensor in a well-known manner.

In the next step, a cyclic engine speed signal is computed based on the instantaneous engine speed signal, the cyclic engine speed signal representing the variations from an average speed signal. In particular, such variations are cyclic due to the periodic operation of the pistons and the crankshaft, superposed on a comparatively slowly variable average engine speed. In other words, the instantaneous engine speed signal contains two main data, which are a mean engine speed (DC component) and a substantially cyclic variation of the engine speed (AC component). The cyclic engine speed depends on the crankshaft torque balance variation between the combustion and the load. The combustion torque varies at the engine's individual cylinder rate whereas the load torque varies slowly and is typically considered as a constant over an engine cycle. Considering the location of the CPS, the load torque is related to a brake or clutch torque.

The cyclic engine speed signal is averaged over some time period. The time period may be engine segment duration, e.g. the time interval between two consecutive top dead center events of the engine. This period of time may be, in particular, in a four-cylinder four-stroke engine the time required for the crankshaft to perform a 180° half-rotation.

According to the present description, the averaged cyclic engine speed signal is corrected for engine losses, and the combustion torque based on the corrected averaged cyclic engine speed signal is calculated. In this way, the combustion torque can be determined more accurately, in particular more accurately than by evaluating the peak-to-peak variation of the instantaneous engine speed signal, which may be more affected by measurement noise. The inventive method does not require any additional sensor.

It is preferred that the cyclic engine speed signal is calculated by subtracting an average engine speed from the instantaneous engine speed signal, normalizing the resulting engine speed signal by subtracting a reference engine speed signal and rectifying the normalized engine speed signal. The average engine speed can be obtained by low-pass filtering, in particular. The reference engine speed signal serves for removing predictable or reproducible effects which otherwise would reduce the accuracy of the estimation of the torque. Moreover, the resulting normalized engine speed signal is rectified, e.g. negative values occurring when the instantaneous engine speed is less than the average engine speed are inverted. In this way, a more reliable basis for estimating the combustion torque is provided.

In particular, the reference engine speed signal represents inertial effects. Such inertial effects arise from the motion of the pistons and the crankshaft, in particular. By removing such inertial effects, the accuracy of the torque estimation is enhanced.

According to a preferred example of the inventive method the reference engine speed signal is updated during the operation of the internal combustion engine. In a vehicle equipped with the internal combustion engine, this could be carried out in any driving situation where there is no combustion, e.g. no fuel is injected. For example, such a situation happens during an overrun phase, when a gear is engaged, the vehicle is not braking and the gas pedal signal is zero so that the vehicle speed and the engine speed are decreasing. It is then possible to record the instantaneous engine speed signal of the overrun. The reference signal obtained when no combustion occurs may then be stored as an update of the reference signal for inertia compensation. The update may replace an existing reference signal completely by a new reference signal, or the existing signal may be replaced by a weighted sum of the existing and the new reference signals. Moreover the weights employed may be adjusted by a confidence or plausibility check. In this way, it can be guaranteed that the inertial effects can be compensated for in a most reliable manner, thus further enhancing the accuracy of the torque estimation. Such updates, which may be performed automatically, are particularly advantageous if the clutch or the electronic engine control unit have been replaced.

In a preferred manner, the engine losses are corrected by employing a map depending on engine operation parameters, such as the current temperature and/or the average engine speed, e.g. such a map can be created during calibration of the engine individually, or referring to a particular engine type. In this way, engine losses can be accounted for simply and accurately.

It has been found that the engine losses to be corrected may arise from a variety of effects. In particular, the engine losses may comprise losses by accessories, losses by pumping, losses by friction, in particular internal rubbing friction, heat losses and exhaust losses. Each of such losses may be compensated for by means of a separate map, e.g., or a map may be employed that allows the correction of a multiplicity of losses. Preferentially, the combustion torque is estimated based on a map or on maps depending on an average engine speed and the corrected averaged cyclic engine speed signal. In this way, a most accurate determination of the combustion torque can be achieved.

An inventive control unit for an internal combustion engine may comprise a sensor input for receiving a crankshaft position sensor signal, processor means for evaluating the crankshaft position sensor signal, and data storage means for storing data such as a reference signal. The control unit is configured for estimating the combustion torque by a method as described above. In particular, the processor means are programmed accordingly. The control unit may also comprise a signal output for displaying a torque value or other information, such as concerning the reference signal update. The control unit may constitute an electronic engine management unit.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 46 and exhaust manifold 48 via respective intake valve 52 and exhaust valve 54. Each intake and exhaust valve may be operated by an intake cam 51 and an exhaust cam 53. The opening and closing time of exhaust valve 54 may be adjusted relative to crankshaft position via cam phaser 58. The opening and closing time of intake valve 52 may be adjusted relative to crankshaft position via cam phaser 59. The position of intake cam 51 may be determined by intake cam sensor 55. The position of exhaust cam 53 may be determined by exhaust cam sensor 57.

Intake manifold 46 is shown communicating with optional electronic throttle 62 which adjusts a position of throttle plate 64 to control air flow from intake boost chamber 44. Compressor 162 draws air from air intake 42 to supply intake boost chamber 44. Exhaust gases spin turbine 164 which is coupled to compressor 162, thereby compressing air that enters the engine. Waste gate 171 may be at least partially opened as pressure in boost chamber 44 reaches a threshold pressure. In this example, waste gate 171 includes an electrically operated waste gate actuator 172. The electrically operated waste gate actuator 172 may be a motor, solenoid, or other electrical actuator. The position of waste gate 171 may be determined via waste gate position sensor 173. Waste gate current control circuit 177 monitors and controls current to electrically operated waste gate actuator 172.

Fuel injector 66 is shown positioned to inject fuel directly into cylinder 30, which is known to those skilled in the art as direct injection. Alternatively, fuel may be injected to an intake port, which is known to those skilled in the art as port injection. Fuel injector 66 delivers liquid fuel in proportion to the pulse width of signal FPW from controller 12. Fuel is delivered to fuel injector 66 by a fuel system (not shown) including a fuel tank, fuel pump, and fuel rail (not shown). Fuel injector 66 is supplied operating current from driver 68 which responds to controller 12. In one example, a low pressure direct injection system may be used, where fuel pressure can be raised to approximately 20-30 bar. Alternatively, a high pressure, dual stage, fuel system may be used to generate higher fuel pressures.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of turbocharger compressor 164 and catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing force applied by foot 132; a measurement of engine manifold absolute pressure (MAP) from pressure sensor 122 coupled to intake manifold 46; a measurement of boost pressure from pressure sensor 123; a measurement of air mass entering the engine from sensor 120; and a measurement of throttle position from a sensor 5. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

In some examples, the engine may be coupled to an electric motor/battery system in a hybrid vehicle. The hybrid vehicle may have a parallel configuration, series configuration, or variation or combinations thereof. Further, in some embodiments, other engine configurations may be employed, for example a diesel engine.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 46, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

Referring now to FIG. 2, an example of the instantaneous engine speed signal nᵢₙₛₜ at a steady state condition of 2000 rpm is shown graphically in FIG. 2 for a number of different torque set-points. The x axis represents the number of teeth passed during one engine revolution, in particular the number of falling edges detected by the encoder of the CPS or interpolated when missing teeth are encountered. As one tooth corresponds to an angular increment of 6°, the total x axis shown in FIG. 2 is one complete engine crankshaft revolution of 360 crankshaft degrees. The engine employed for the measurements depicted in FIG. 2 was a four-stroke four-cylinder internal combustion engine. Therefore, two cylinders fire over one complete engine revolution, the respective combustion events and durations being indicated by the horizontal double arrows in the upper part of FIG. 2. Two consecutive segments are indicated below the x axis, each segment comprising the period from the top dead centre position of one cylinder just before or about the beginning of combustion to the consecutive top dead centre position of the cylinder firing next. The y axis represents the instantaneous engine speed nᵢₙₛₜ.

The set of curves shown in FIG. 2 was obtained by maintaining the mean engine speed nₘₑₐₙ to a nominal 2000 rpm, while the demanded torque was increased from motoring condition, e.g. 0 Nm (curve 201) to about 300 Nm (curve 207). The other curves correspond to intermediate torque set-points, which are 47 Nm (curve 202), 103 Nm (curve 203), 151 Nm (curve 204), 201 Nm (curve 205), and 250 Nm (curve 206), respectively, as indicated in the insert in the upper right corner of FIG. 2. The minimum engine speed values of each curve correspond to the top dead centres of the firing cylinders. Each combustion is accelerating the crankshaft, leading to an increase of the instantaneous engine speed nᵢₙₛₜ. An example for the noise-corrected amount of increase of the instantaneous speed is indicated by the vertical double arrow in FIG. 2. As can be seen in FIG. 2, an increased torque results in an increased variation of the instantaneous engine speed signal during an engine segment. This variation forms an AC component of the instantaneous engine speed signal.

The principle of the algorithm for torque estimation according to an example of the present description is explained with reference to FIG. 3. The method of FIG. 3 may be stored as executable instructions in non-transitory memory of controller 12 of FIG. 1.

At 302, method 300 gathers the time interrupts from the low to high or from high to low of the tooth transitions of the target wheel are acquired from the crankshaft position sensor (CPS). Individual tooth periods are formed by computing the time interval between two consecutive interrupts of the same kind, e.g. from low to high or from high to low. In the method shown in FIG. 3, the time interrupts corresponding to the falling edges of the target wheel teeth are detected and the time intervals or tooth periods between consecutive interrupts determined at 304. Missing teeth due to a gap used as an angular reference position are reconstructed by interpolation at 306. Raw tooth speeds are formed by inverting the raw tooth period. The raw tooth speeds represent the instantaneous engine speed nᵢₙₛₜ.

At 308, an average tooth speed representing a mean engine speed nₘₑₐₙ is obtained with a low-pass filter from the raw tooth speeds. The low-pass filter may be characterized by the low-pass filter order consisting, e.g., in the number of teeth per engine segment interrupt, e.g. from one top dead centre event to the next top dead centre event. The low-pass filtered raw tooth speed can be considered a DC component of the instantaneous engine speed nᵢₙₛₜ. By subtracting the average tooth speed from the raw tooth speed, an AC component n_{AC} of the instantaneous engine speed nᵢₙₛₜ is formed:

n_{AC}=nᵢₙₛₜ−nₘₑₐₙ

The resulting AC speed signal is normalized by subtracting a reference engine speed signal n_{ref,} and the normalized engine speed signal is rectified to form an inertia compensated AC speed signal or cyclic tooth signal at 310, which is an absolute magnitude of the normalized AC speed signal:

n_{AC,in}=|n_{AC}−n_{ref}|

The reference engine speed signal serves to compensate for inertial effects due to oscillating masses, the inertial effects increasing with the engine speed. Thus, the reference engine speed signal employed for the inertial compensation depends on nₘₑₐₙ, which is the current mean engine speed. The inertia compensated AC speed signal n_{AC,in} is averaged over an engine segment duration, which is the time interval from one top dead centre event to the next top dead centre event. The resulting averaged inertia compensated AC speed signal n_{cyc,in} may be further compensated for boost pressure effects, which can be determined based on the signal of a boost pressure sensor or based on engine and turbocharger operation parameters at 312. The result is a segment averaged cyclic engine speed signal n_{cyc}, in which inertial and boost pressure effects have been compensated for. The segment averaged cyclic engine speed signal n_{cyc} is determined continuously for a continuous crankshaft torque monitoring.

The torque estimate at 318 is based on the cyclic speed n_{cyc} determined in the previous steps. For example, the contribution of pumping losses is removed, based on a map depending on an engine temperature and the mean engine speed nₘₑₐₙ. The torque is estimated based on a map depending on mean engine speed nₘₑₐₙ and averaged cyclic speed n_{cyc}. The map may depend on an engine temperature. The torque difference between a hot and a cold engine may be corrected by a parameter depending on the temperature of the engine, e.g. the coolant temperature provided by a coolant temperature sensor. In this way, an estimated combustion torque T_{comb,est} is determined with an increased accuracy, based on existing sensor signals.

In an intermediate step 314, a dependency of a brake torque T_{brake} on the mean engine speed nₘₑₐₙ and on the cyclic engine speed n_{cyc} may be accounted for by means of a look-up table and an estimated brake torque T_{brake,est} determined. Moreover, a filter may be employed such as a PT-1 element filter with an order limited to the number of cylinders of the internal combustion engine, and/or a finite impulse response (FIR) order over at most one engine cycle. An FIR filter may be resettable depending on the cyclic speed gradient with respect to the average speed nₘₑₐₙ in order to reduce or avoid the FIR filter's inherent lag during a speed or load change.

At 320, method 300 adjusts an actuator in response to the engine torque estimate. In one example, method 300 increases a throttle opening amount when the engine torque estimate is less than a desired engine torque. Further, the amount of fuel injected to engine cylinders may be increased when the engine torque estimate is less than a desired engine torque. Further, a transmission gear may be changed by supplying oil to a transmission clutch in response to the estimated engine torque. Method 300 exits after the actuator is adjusted.

Referring now to FIG. 4, the reference engine speed signal n_{ref} employed for inertia compensation can be updated during a drive cycle, as is shown in FIG. 4 in a simplified flow diagram. This could be carried out in particular at any driving situation where there is no combustion, e.g. no fuel is injected, for example, during an overrun phase. The method of FIG. 4 may be stored as executable instructions in non-transitory memory of controller 12 of FIG. 1.

At 402, in order to enter into the update mode, a number of entry conditions are checked, concerning in particular, whether the accelerator pedal is in rest position, the clutch is engaged, a gear is engaged and the brake is not active. Moreover, the number of updates realized for the current breakpoint or mean engine speed nₘₑₐₙ and the time elapsed since the last successful updates are checked. If the entry conditions are fulfilled, the current mean engine speed nₘₑₐₙ is determined and stored at 406. The CPS signal is evaluated for recording the instantaneous engine speed nᵢₙₛₜ for one engine cycle and one or a few further tooth margin detections depending on a required interpolation.

At 408, before the data obtained in this way are employed for updating the reference signal, a consistency check is performed including, e.g., a check of the number of teeth detected, a comparison of the mean engine speeds across the different cylinder segments, and a comparison of the current measurement to an expected pattern depending on the mean engine speed in order to remove CPS measurement errors (spikes). If the consistency check indicates that the current measurement is correct, the data are stored for updating the inertia compensation at 412. An update may replace existing reference values with the new values. Alternatively, for an update a weighted sum of the existing values with the newly recorded values may be formed, the weighted sum replacing the existing reference speed. If the consistency check is negative, the data are rejected at 414. Depending on the kind of inconsistency detected, a message may be provided to a diagnostic system indicating, e.g., a deficiency of the clutch system.

It is thus possible to employ the instantaneous engine speed signal nᵢₙₛₜ of the overrun phase, after suitable filtering and consistency checking, for correction of the torque when no combustion occurs, and thus as a reference engine speed n_{ref}.

As will be appreciated by one of ordinary skill in the art, routines described in FIGS. 3 and 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. A method for operating an engine, comprising:
adjusting an actuator in response to an estimated engine combustion torque, the estimated engine combustion torque based on an engine loss corrected averaged cyclic speed as determined from an averaged cyclic engine speed, the averaged cyclic engine speed based on a cyclic engine speed, the cyclic engine speed based on an instantaneous engine speed.

2. The method of claim 1, where the cyclic engine speed is determined by subtracting an average engine speed from the instantaneous engine speed, where a normalized engine speed is provided by normalizing a resulting engine speed via subtracting a reference engine speed, and rectifying the normalized engine speed.

3. The method of claim 2, where the reference engine speed represents inertial effects.

4. The method of claim 2, where the reference engine speed is updated during operation of the engine.

5. The method of claim according to claim 1, where a correction for engine losses is based on a map depending on engine operation parameters.

6. The method of claim 1, where the engine loss corrected average cyclic speed includes correction for engine losses caused by engine accessories.

7. The method of claim 1, where the engine loss corrected average cyclic speed includes correction for engine losses caused by engine pumping.

8. The method of claim 1, where the engine loss corrected average cyclic speed includes correction for engine losses caused by engine friction.

9. The method of claim 1, where the engine loss corrected average cyclic speed includes correction for engine heat losses.

10. The method of claim 1, where the engine loss corrected average cyclic speed includes correction for exhaust losses.

11. The method of claim 1, where the estimated engine combustion torque is based on a map depending on an average engine speed and the engine loss corrected averaged cyclic engine speed.

12. A method for operating an engine, comprising:
providing an averaged cyclic engine speed from a cyclic engine speed, the cyclic engine speed provided by subtracting an average engine speed from an instantaneous engine speed, providing a normalized engine speed via subtracting a reference speed from a resulting engine speed, and rectifying the normalized engine speed; and
adjusting an actuator in response to the averaged cyclic engine speed.

13. The method of claim 12, where the actuator is adjusted in response to a combustion torque estimate based on a map depending on the averaged cyclic engine speed.

14. The method of claim 13, where the map depends further on the average engine speed.

15. A system for operating an engine, comprising:
an engine;
an actuator coupled to the engine;
a speed sensor coupled to the engine; and
a controller including non-transitory instructions to adjust a position of the actuator in response to an estimated engine combustion torque, the estimated engine combustion torque based on an engine loss corrected averaged cyclic speed as determined from an averaged cyclic engine speed, the averaged cyclic engine speed based on a cyclic engine speed, the cyclic engine speed based on an instantaneous engine speed.

16. The system of claim 15, comprising additional instructions to determine the cyclic engine speed by subtracting an average engine speed from the instantaneous engine speed, providing a normalized engine speed via subtracting a reference engine speed, and rectifying the normalized engine speed.

17. The system of claim 16, where the reference engine speed represents inertial effects.

18. The system of claim 16, where the reference engine speed is updated during operation of the engine.
